(19) United States
(12) Patent Application Publication
(10) Pub. No.: US 2017/0123606 A1
(43) Pub. Date: May 4, 2017

(54) ELECTRONIC DEVICE AND METHOD FOR SEARCHING DATA

(71) Applicant: KABUSHIKI KAISHA TOSHIBA, Tokyo (JP)

(72) Inventor: Sachie Yamauchi, Tachikawa Tokyo (JP)

(21) Appl. No.: 15/336,390

(22) Filed: Oct. 27, 2016

Related U.S. Application Data
(60) Provisional application No. 62/248,239, filed on Oct. 29, 2015.

(51) Int. Cl. G06F 3/0482; G06F 17/30; G06F 3/0481

(52) U.S. Cl. CPC G06F 3/0482; G06F 3/04817; G06F 17/30713; G06F 17/30619; G06F 17/30699

(57) ABSTRACT

According to one embodiment, an electronic device includes a memory that stores files and a hardware processor. The hardware processor determines, if a first keyword is input, first files including the first keyword, of the files, determines a first period to classify the first files with respect to dates of generation or dates of updating, and a second keyword to classify the first files, displays a first icon indicative of a first group of the first files which have been generated or updated in the first period and which include the second keyword, and displays the first files which have been generated or updated in the first period and which include the second keyword if the first icon is selected.

### CROSS-REFERENCE TO RELATED APPLICATIONS

This application claims the benefit of U.S. Provisional Application No. 62/248,239, filed Oct. 29, 2015, the entire contents of which are incorporated herein by reference.

### FIELD

Embodiments described herein relate generally to technology for searching text data.

### BACKGROUND

Recently, various electronic devices such as personal computers (PC), tablets and smartphones have been developed. These types of electronic devices can handle various types of files (data) such as documents, mails, and Web pages, which include texts. In addition, files can be searched with a keyword, in these types of electronic devices.

When files are searched with a keyword, for example, a list of files including the keyword is displayed on a screen as a search result. The user can use a necessary file in the file list.

Incidentally, if the number of characters of the keyword is small or the number of keywords is small, the number of files displayed as the search result is often large. The user needs to execute, for example, change or addition of keywords in order to narrow the files, and this operation is complicated for the user.

In addition, a keyword useful to narrow the files cannot be input and the search result (file) which the user intends often cannot be obtained.

Implementation of new assistance technology enabling the search result which the user intends to be easily obtained is therefore required.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic device according to an embodiment.

FIG. 2 is an exemplary block diagram showing a system configuration of the electronic device.

FIG. 3 is an exemplary diagram showing a functional configuration of a search program executed by the electronic device.

FIG. 4 is an exemplary diagram showing index data generated by the electronic device executing the search program.

FIG. 5 is an exemplary diagram for explanation of processing of generating a first filter.

FIG. 6 is an exemplary diagram for explanation of processing of generating a second filter.

FIG. 7 is an exemplary diagram showing a first search result view displayed by the electronic device executing the search program.

FIG. 8 is an exemplary diagram showing a second search result view displayed by the electronic device executing the search program.

FIG. 9 is an exemplary diagram showing a third search result view displayed by the electronic device executing the search program.

FIG. 10 is an exemplary diagram showing a fourth search result view displayed by the electronic device executing the search program.

FIG. 11 is an exemplary flowchart showing the procedure of indexing processing.

FIG. 12 is an exemplary flowchart showing the procedure of search processing.

FIG. 13 is an exemplary flowchart showing the procedure of first filter generation processing.

FIG. 14 is an exemplary flowchart showing the procedure of second filter generation processing.

FIG. 15 is an exemplary diagram showing a functional configuration of search programs executed by an electronic device (client computer) and an external electronic device (server computer).

FIG. 16 is an exemplary flowchart showing the procedure of search processing executed by the client computer.

FIG. 17 is an exemplary flowchart showing the procedure of search processing executed by the server computer.

### DETAILED DESCRIPTION

Various embodiments will be described hereinafter with reference to the accompanying drawings.

In general, according to one embodiment, an electronic device includes a screen, a memory and a hardware processor. The memory stores files. The hardware processor is configured to: determine, if a first keyword is input, first files including the first keyword, of the files; determine a first period and a second period to classify the first files with respect to dates of generation or dates of updating, and a second keyword and a third keyword to classify the first files; display a first icon, a second icon, a third icon and a fourth icon on a screen, the first icon indicative of a first group of the first files which have been generated or updated in the first period and which include the second keyword, the second icon indicative of a second group of the first files which have been generated or updated in the first period and which include the third keyword, the third icon indicative of a third group of the first files which have been generated or updated in the second period and which include the second keyword, the fourth icon indicative of a fourth group of the first files which have been generated or updated in the second period and which include the third keyword; and display the first files which have been generated or updated in the first period and which include the second keyword, on the screen, if the first icon is selected. The first icon, the second icon, the third icon and the fourth icon are arranged two-dimensionally in accordance with periods determined by one of axes and keywords determined by the other axis.

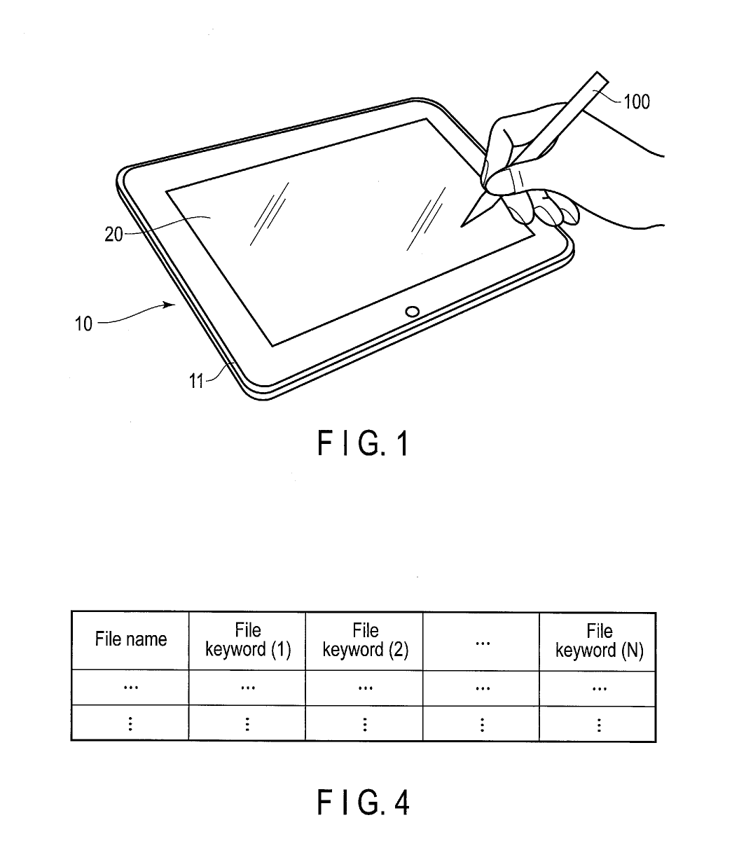

FIG. 1 is a perspective view showing an appearance of the electronic device according to the embodiment. The electronic device is, for example, a portable electronic device capable of inputting with a pen or a finger. The electronic device can be implemented as a tablet computer, a notebook-type personal computer, a smartphone, a PDA, or the like. In the following explanations, it is assumed that the electronic device is implemented as a tablet computer 10. The tablet computer 10 is a portable electronic device called a tablet or a slate computer and includes a body 11 and a touchscreen display 20 as shown in FIG. 1. The touchscreen display 20 is mounted on the body 11 so as to be laid on the upper surface of the body 11.

The body 11 has a housing shaped in a thin box. A flat panel display and a sensor configured to detect a contact position of a pen or a finger on a screen of the flat panel display are incorporated in the touchscreen display 20. The flat panel display may be, for example, a liquid crystal display (LCD). For example, a capacitive touch panel or an electromagnetic induction digitizer may be used as the sensor. In the following explanations, it is assumed that both two types of sensors, i.e., a digitizer and a touch panel, are incorporated in the touchscreen display 20.

Each of the digitizer and the touch panel is provided to cover the screen of the flat panel display. The touchscreen display 20 can detect not only a touch operation on the screen with a finger but also a touch operation on the screen with a pen 100. The pen 100 is, for example, an electromagnetic induction pen.

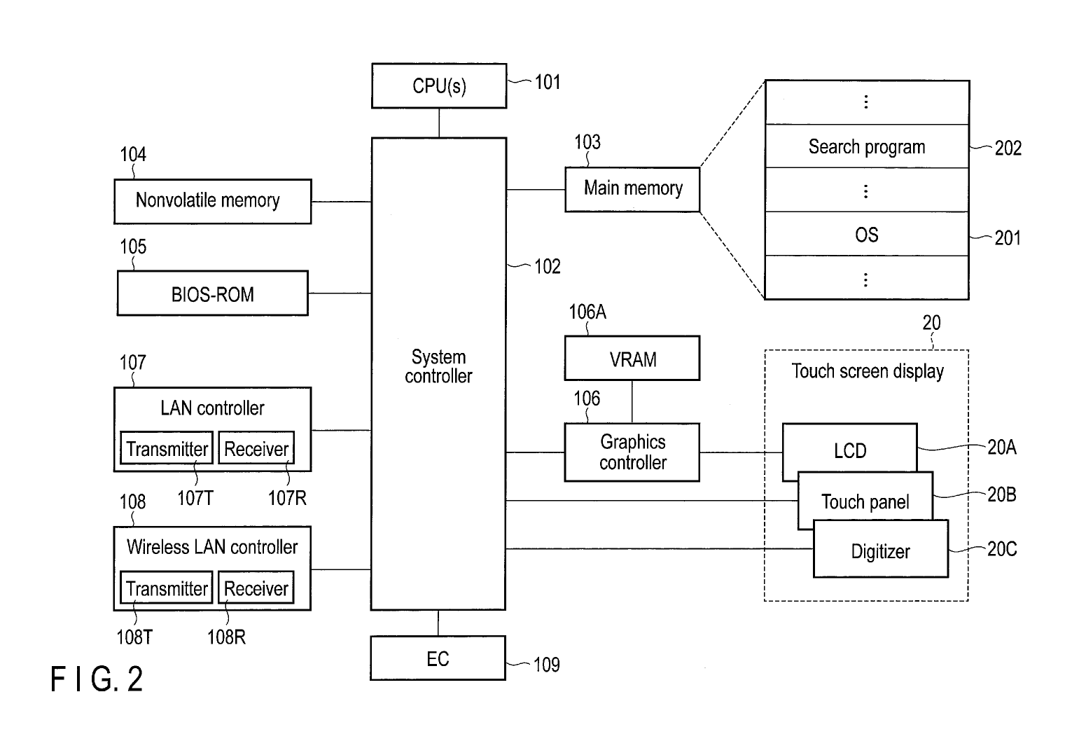

FIG. 2 shows a system configuration of the tablet computer 10.

As shown in FIG. 2, the tablet computer 10 includes a CPU 101, a system controller 102, a main memory 103, a nonvolatile memory 104, a BIOS-ROM 105, a graphics controller 106, a video RAM (VRAM) 106A, a LAN controller 107, a wireless LAN controller 108, an embedded controller (EC) 109, and the like.

The CPU 101 is a hardware processor configured to control the operations of components in the tablet computer 10. The processor includes a circuit (processing circuit). In addition, not only one processor, but also plural processors may be provided. The CPU 101 executes various programs loaded from the nonvolatile memory 104 to the main memory 103. The programs include an operating system (OS) 201 and various application programs. The application programs include a search program 202. The CPU 101 executes instructions included in the search program 202.

Several characteristics of the search program 202 will be explained here.

The search program 202 includes indexing instructions for generating index data corresponding to files stored in the nonvolatile memory 104 or the like. The indexing instructions include instructions for determining a keyword (hereinafter also referred to as a file keyword) representing a file based on words and phrases included in a text in the file and generating index data (record) including the determined file keyword.

In addition, the search program 202 includes search instructions for searching files stored in the nonvolatile memory 104 or the like with a keyword (hereinafter also referred to as a search keyword) composed of characters input by the user. The CPU 101 executing the search instructions allows files including the search keyword to be extracted from the files, by using index data 104B generated by the CPU 101 executing the indexing instructions.

Furthermore, the search program 202 includes search assistance instructions for classifying files including the search keyword into groups of an update date and a keyword different from the search keyword. The search assistance instructions include instructions for dynamically detecting periods and keywords effective to further narrow the files including the search keyword by analyzing a tendency of contents of the files including the search keyword (for example, a tendency applied to a number of files, a tendency applied to a specific file alone, or the like). By presenting the keywords and the periods for narrowing, the user can be assisted so as to enable a necessary file to be easily searched from the files including the search keyword. In other words, in accordance with the user's inputting the search keyword at one time, conditions of keywords and periods can be added to the search result based on the search keyword and a content corresponding to the result of searching can be displayed on the screen.

The indexing instructions, the search instructions and the search assistance instructions included in the search program 202 can be incorporated in a circuit such as a hardware processor. Alternatively, these instructions can also be incorporated in dedicated circuits, respectively.

The CPU 101 also executes a basic input/output system (BIOS) stored in the BIOS-ROM 105. The BIOS is a program for hardware control.

The system controller 102 is a device configured to make connection between a local bus of the CPU 101 and various components. The system controller 102 incorporates a memory controller which controls access to the main memory 103. In addition, the system controller 102 also has a function of communicating with the graphics controller 106 via a serial bus conforming to the PCI EXPRESS standard or the like.

An ATA controller, which controls the nonvolatile memory 104, is built in the system controller 102.

The graphics controller 106 is a display controller configured to control an LCD 20A of the touch screen display 20. The display controller includes a circuit (i.e., a display control circuit). The graphics controller 106 receives data for display on the LCD 20A from the CPU 101 and transfers the data to the VRAM 106A. The graphics controller 106 generates a display signal which is to be output to the LCD 20A, by using data stored in the VRAM 106A. The graphics controller 106 transmits the generated display signal to the LCD 20A.

The LCD 20A displays a screen image, based on the display signal. A touch panel 20B and a digitizer 20C which cover the LCD 20A function as sensors configured to detect a contact position between the screen of the LCD 20A and an external object.

The LAN controller 107 is a wired communication device configured to execute wired communication of, for example, IEEE 802.3 Standard. The LAN controller 107 includes a transmitter (transmission circuit) 107T configured to transmit the signal and a receiver (reception circuit) 107R configured to receive the signal. The wireless LAN controller 108 is a wireless communication device configured to execute wireless communication of, for example, IEEE 802.11 Standard. The wireless LAN controller 108 includes a transmitter (transmission circuit) 108T configured to wirelessly transmit the signal and a receiver (reception circuit) 108R configured to wirelessly receive the signal. The tablet computer 10 may be provided with a communication device configured to execute communication of the other standards such as 3G/4G/LTE and Bluetooth (registered trademark).

The EC 109 is a single-chip microcomputer including an embedded controller for power management. In addition, the EC 109 powers on and off the tablet computer 10 in response to user operations on the power button.

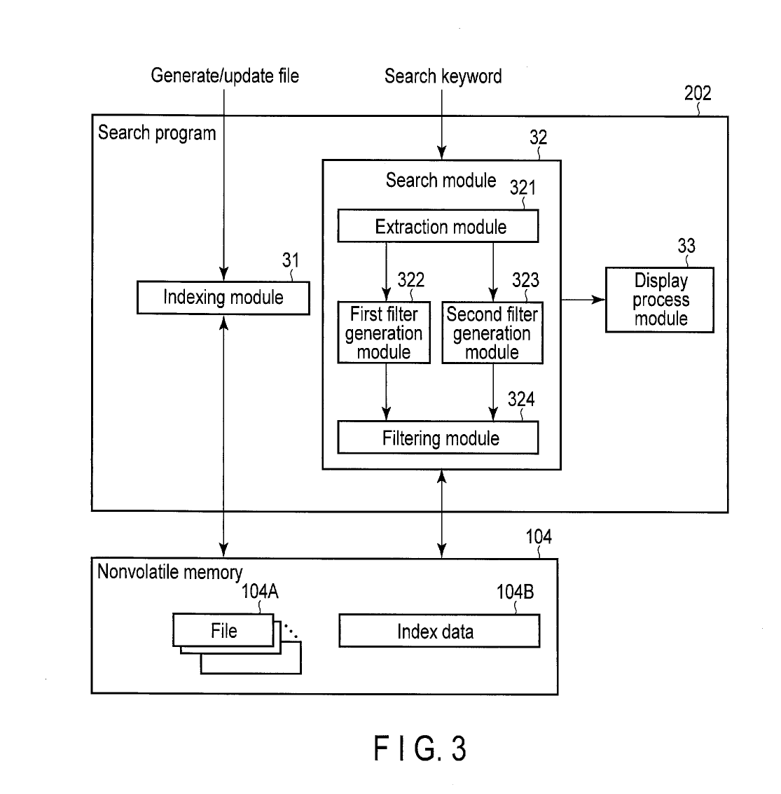

FIG. 3 shows a functional configuration of the search program 202.

The search program 202 includes an indexing module 31, a search module 32 and a display process module 33 as functional modules of the program.

Each of the modules in the search program 202 includes instructions for receiving various events from the touch panel 20B and the digitizer 20C. The events include a touch event, a move event, and a release event. The touch event is an event indicating that an external object has made contact with the screen of the LCD 20A. The touch event includes a contact position of the screen and the external object. The move event is an event indicating that the contact position has been moved while the external object is in contact with the screen. The move event includes coordinates of the contact position of a movement destination. The release event is an event indicating that the contact between the external object and the screen has been released. The release event includes coordinates of the release position at which the contact has been released. Each of the modules in the search program 202 includes instructions for detecting at which part of the screen and which gesture (tap, double tap, tap and hold, swipe, pan, pinch, stretch or the like) has been executed, based on various received events.

The indexing module 31 includes instructions for generating, if a file is stored in the nonvolatile memory 104, index data corresponding to the file. The stored file may be a newly generated file or a file updated by editing an already stored file. The index data is used to search the stored file with a keyword.

More specifically, the indexing module 31 includes instructions for detecting, if a file is stored in the nonvolatile memory 104, words from a text included in the file. For example, the indexing module 31 includes instructions for detecting, if an English text is included in the file, words sectioned by spaces (i.e., character codes corresponding to spaces), from the text. In addition, for example, the indexing module 31 includes instructions for detecting, if a Japanese text is included in the file, words by subjecting morphological analysis to the text.

The indexing module 31 includes instructions for excluding words inappropriate to the search, from the detected words, with, for example, dictionary data (linguistic knowledge). The words inappropriate to the search include, for example, words of specific parts of speech (for example, conjunction, preposition, and the like) and words considered to appear in any documents (for example, “is”, “have”, and the like).

The indexing module 31 includes instructions for selecting a word, which is to be used as a file keyword, from the remaining words. More specifically, the indexing module 31 includes instructions for counting the number of times of appearance of the remaining words, per word. The indexing module 31 includes instructions for determining a word, which is to be used as a file keyword, of the remaining words, by using the counted number of times of appearance of each word. The indexing module 31 includes instructions for determining, for example, a predetermined number of (for example, ten) words in order of more number of times of appearance, as the file keywords. In addition, the indexing module 31 may include instructions for determining, for example, all the words having the number of times of appearance more than or equal to a predetermined number (for example, five), as the file keywords. Furthermore, the indexing module 31 may include instructions for determining all the remaining words as the file keywords.

An idiom composed of words (for example, “new product”) may be used as the file keyword. The indexing module 31 includes instructions for detecting idioms composed of words, in the text in the file, and counting the number of times of appearance of each idiom, by using the dictionary data (linguistic knowledge). The indexing module 31 includes instructions for determining the word and idiom, which are to be used as file keywords, of the words and idioms appearing in the file, based on the counted number of times of appearance.

The indexing module 31 includes instructions for generating a record of the index data 104B, by using the determined file keywords.

FIG. 4 shows a configuration example of the index data 104B used by the CPU 101 executing the search program 202. A table of the index data 104B includes records corresponding to the files. Each of the records includes a “file name” field and at least one “file keyword” field. Each record may include the “file keyword” fields in accordance with the number of keywords extracted from the corresponding file.

In a record corresponding to a certain file, the file name is described in the “file name” field. A path of the file may be described in the “file name” field. The keywords extracted from the text included in the file are described in the respective “file keyword” fields.

The indexing module 31 includes instructions for generating, if the file is a newly generated file, a record corresponding to the file, by using the determined file keywords, and adding the record to the index data 104B in the nonvolatile memory 104. The indexing module 31 includes instructions for updating, if the file is an updated file, a record corresponding to the file, in the index data 104B, by using the determined file keywords.

It should be noted that the CPU 101 executing the indexing module 31 can generate index data corresponding not only to the files stored in the nonvolatile memory 104, but also to files stored in several storage mediums which can be accessed by the tablet computer 10.

The search module 32 includes instructions for searching the files stored in the nonvolatile memory 104, with a search keyword (first keyword) input by the user. The search module 32 includes instructions for determining the files including the search keyword, by using the index data 104B stored in the nonvolatile memory 104. The search keyword may include not only one word, but also plural words. In addition, the search module 32 includes instructions for generating filters of a keyword and a time (period) to narrow the files, by analyzing the files including the search keyword, and filtering the files including the search keyword, with the generated filters.

The search module 32 includes an extraction module 321, a first filter generation module 322, a second filter generation module 323, and a filtering module 324.

The extraction module 321 includes instructions for extracting files (hereinafter also referred to as first files) including the search keyword from the files 104A stored in the nonvolatile memory 104, with the index data 104B. The extraction module 231 includes instructions for specifying the record in which the search keyword is described in the “file keyword” field, in the index data 104B. Further, the extraction module 321 includes instructions for determining a file corresponding to the record (i.e., a file indicated in the “file” field of the record) as the file including the search keyword.

The first filter generation module 322 and the second filter generation module 323 include instructions for generating filters if, for example, the number larger than or equal to a first threshold value, of files, are extracted by the CPU 101 executing the extraction module 321. The first filter generation module 322 and the second filter generation module 323 include instructions for generating filters effective to narrow the files including the search keyword. The filters narrow the files, based on file attributes such as the keyword, the date of generation, the date of updating, extension (file type), positional information, and the like. In addition, the filters effective for narrowing are filters which enable the files including the search keyword to be narrowed to, for example, the number smaller than or equal to a predetermined number, of files.

The first filter generation module 322 includes instructions for determining periods to classify the files (first files) including the search keyword with respect to the dates of generation or the dates of updating (or the dates and times of generation or the dates and times of updating). The first filter generation module 322 includes instructions for generating a first filter to narrow the files including the search keyword to the files in which the dates of generation or the dates of updating are included in the periods, respectively. In other words, the first filter is a time filter to narrow the files including the search keyword into groups of the periods, based on the dates of generation or the dates of updating.

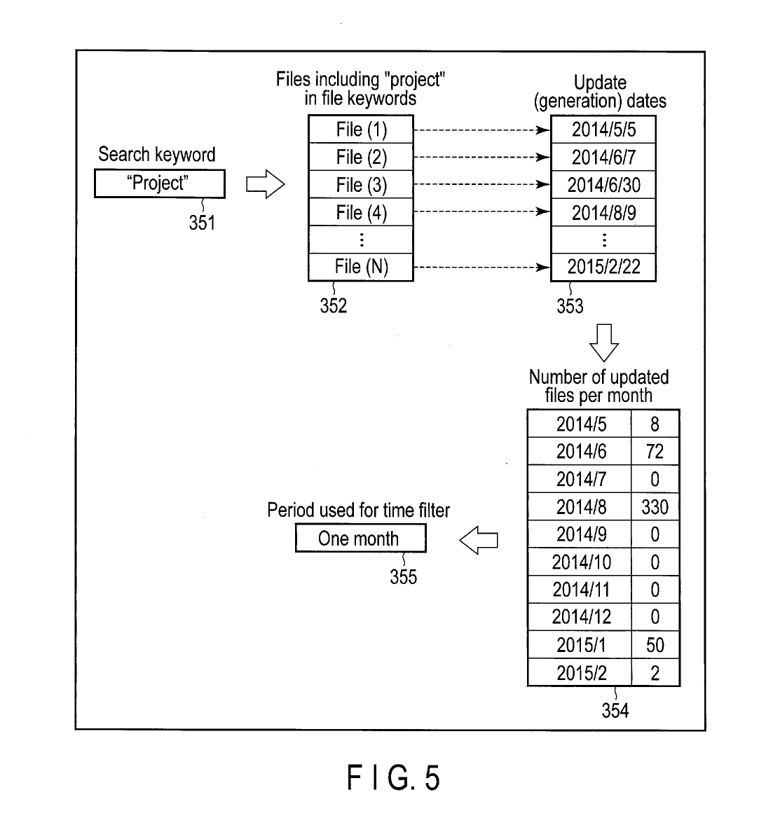

An example of generating the first filter by the CPU 101 executing the first filter generation module 322 will be explained with reference to FIG. 5.

As shown in FIG. 5, when a search keyword “project” 351 is input, the CPU 101 executing the extraction module 321 extracts files (first files) 352 including the search keyword “project” 351 from the files 104A stored in the nonvolatile memory 104. The files 352 including the search keyword “project” 351 are files each having the search keyword “project” 351 described in one of the “file keyword” fields of the associated record of the index data 104B.

The CPU 101 executing the first filter generation module 322 detects an oldest date of updating and a latest date of updating, of the dates of updating (or the dates of generation) 353 of the files 352 and, for each predetermined unit period (time range) in the period, calculates the number of files (hereinafter also referred to as the number of updated files) 354 having the dates of updating in the unit period. The predetermined unit period is a period defined with respect to a year, a month, a week, a date or the like. For example, if all the calculated numbers of updated files in the respective unit periods are smaller than or equal to a fifth threshold value, the CPU 101 executing the first filter generation module 322 sets the predetermined unit period as a period 355 which is to be used for the first filter.

In FIG. 5, the numbers of updated files 354 per month, in the period from the oldest date of updating “2014/5/5” to the latest date of updating “2015/2/22”, of the dates of updating 353 of the files 352, are calculated. Since all the calculated numbers of updated files 354 per month are smaller than or equal to the fifth threshold value (in this case, four hundred), the CPU 101 executing the first filter generation module 322 sets “one month” as the unit period 355 which is to be used for the first filter.

The CPU 101 executing the first filter generation module 322 generates the first filter to classify the files into groups for each predetermined unit period, by using the set unit period 355.

The periods to classify the files with respect to the dates of updating (or the date of generation) may be different in length from each other. The CPU 101 executing the first filter generation module 322 can also set the length of each period such that, for example, the number of files having the dates of updating in each period is smaller than or equal to the fifth threshold value.

In addition, the CPU 101 executing the second filter generation module 323 determines keywords (filter keywords) to classify the files (first files) including the search keyword, by the keywords. The CPU 101 executing the second filter generation module 323 determines, for example, words of the words included in the files including the search keyword as the filter keywords in a case where the number of the files in which the words appear is larger than or equal to a third threshold value and smaller than or equal to a fourth threshold value. This is because a keyword appearing in too many files or too few files is inappropriate for the filter. The third threshold value and the fourth threshold value are preliminarily determined based on, for example, the number of files stored in the nonvolatile memory 104 or the number of items (for example, icons indicative of the files or groups to which the files belong) which can be displayed on the screen of the LCD 20A. The CPU 101 executing the second filter generation module 323 generates a second filter to narrow the files including the search keyword to the files further including one of the filter keywords. In other words, the second filter is a keyword filter to narrow the files including the search keyword into groups, based on the filter keywords.

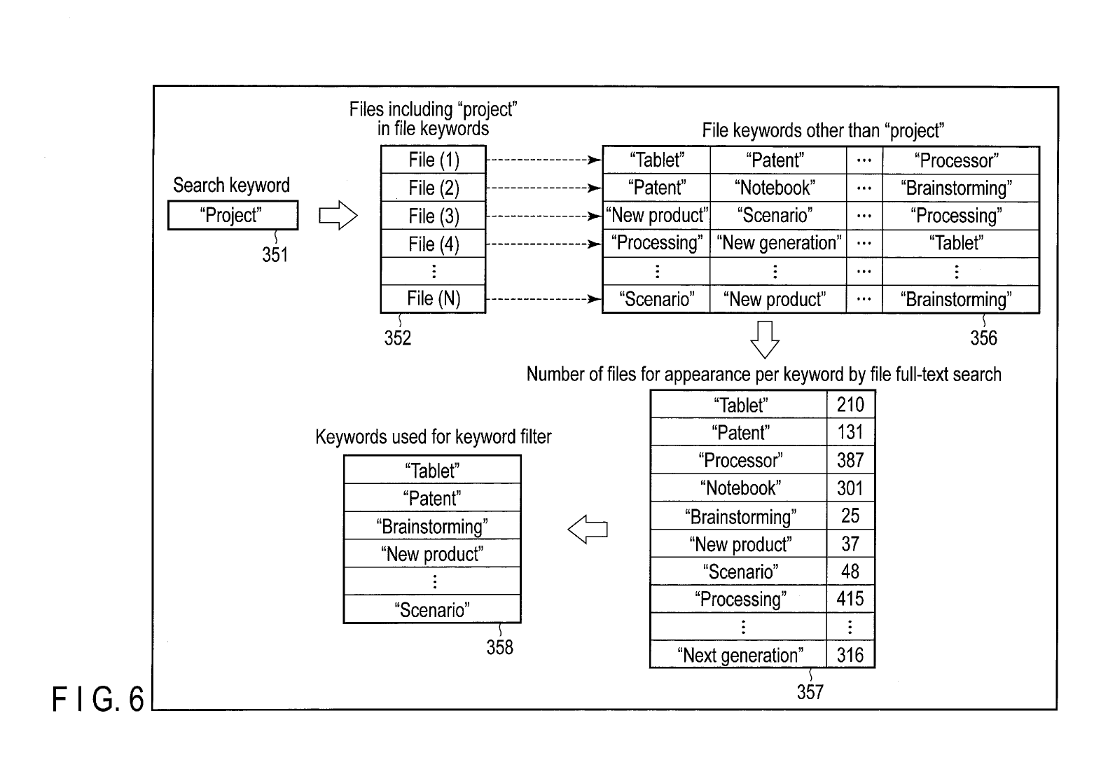

An example of generating the second filter by the CPU 101 executing the second filter generation module 323 will be explained with reference to FIG. 6.

As explained above, when the search keyword “project” 351 is input, the CPU 101 executing the extraction module 321 extracts files (first files) 352 including the search keyword “project” 351 from the files 104A stored in the nonvolatile memory 104. The files 352 including the search keyword “project” 351 are files each having the search keyword “project” 351 described in one of the “file keyword” fields of the associated record of the index data 104B.

The CPU 101 executing the second filter generation module 323 reads file keywords 356 corresponding to the files 352, from the associated records in the index data 104B. The read file keywords 356 are file keywords other than the search keyword “project” 351.

The CPU 101 executing the second filter generation module 323 counts the numbers of files of appearance 357 for the respective file keywords, by executing full-text search in the texts of the files 352 including the search keyword, with the read file keywords. If the counted number of file of appearance 357 is a value, which falls within a predetermined range, the CPU 101 executing the second filter generation module 323 sets the keyword as a filter keyword 358 which are to be used for the second filter. Each of the filter keywords 358 may include words (i.e., may be an idiom).

In FIG. 6, the keywords having the numbers of files of appearance larger than or equal to the third threshold value (in this case, twenty) and smaller than or equal to the fourth threshold value (in this case, three hundred) are set as the filter keywords 358 which are to be used for the second filter.

The CPU 101 executing the second filter generation module 323 generates the second filter to classify the files into groups for the respective keywords, by using the set filter keywords 358.

The extraction module 321 may includes instructions for extracting the files including the search keyword from the files 104A stored in the nonvolatile memory 104, without using the index data 104B. In this case, the extraction module 321 includes instructions for extracting the files 352 including the search keyword by executing the full-text search using the search keyword in the text of the files 104A. The extraction module 321 includes instructions for extracting character strings (hereinafter also referred to as snippets) in a predetermined range including a character string of the search keyword. The second filter generation module 323 includes instructions for determining keywords (filter keywords) to classify the files including the search keyword, from words included in the extracted snippets, by the keywords. For example, the second filter generation module 323 includes instructions for determining words of the words included in the extracted snippets as the filter keywords in a case where the number of the files in which the words appear is larger than or equal to the third threshold value and smaller than or equal to the fourth threshold value.

The filtering module 324 includes instructions for filtering the files 352 including the search keyword, with the generated first filter and second filter. More specifically, the filtering module 324 includes instructions for filtering the files including the search keyword, with the first filter. The filtering module 324 further includes instructions for filtering the files belonging to the groups of the periods, which are the filtering results using the first filter, with the second filter. Thus, the files including the search keyword are classified into the groups of the periods, based on the dates of updating, and the files belonging to each of the groups of the periods are further classified into the groups of the keywords.

The display process module 33 includes instructions for displaying the filtered search results on the screen of the LCD 20A.

More specifically, the display process module 33 includes instructions for displaying, if the number of files including the search keyword is greater than or equal to the first threshold value, on the screen, icons indicative of the groups defined by one of the periods determined by the CPU 101 executing the first filter generation module 322 and one of the filter keywords determined by the CPU 101 executing the second filter generation module 323. The display process module 33 includes instructions for displaying, if one of the displayed icons is selected (for example, tapped), the files belonging to the group of the icon (for example, a list of the icons indicative of the files) on the screen.

For example, the first filter generation module 322 includes instructions for determining a first period and a second period to classify the first files including the search keyword with respect to the dates of generation or the dates of updating. The second filter generation module 323 includes instructions for determining a second keyword and a third keyword to classify the files including the search keyword. The display process module 33 includes instructions for displaying a first icon, a second icon, a third icon and a fourth icon on the screen. The first icon indicates a first group of first files which have been generated or updated in the first period and which include the second keyword. The second icon indicates a second group of first files which have been generated or updated in the first period and which include the third keyword. The third icon indicates a third group of first files which have been generated or updated in the second period and which include the second keyword. The fourth icon indicates a fourth group of first files which have been generated or updated in the second period and which include the third keyword. The first icon, the second icon, the third icon and the fourth icon are arranged two-dimensionally in accordance with the period determined by one of axes and the keyword determined by the other axis.

The display process module 33 includes instructions for displaying, if the first icon is selected from the displayed icons, the first files which have been generated or updated in the first period and which include the second keyword, on the screen.

The display process module 33 includes instructions for displaying, if the number of the files including the search keyword is smaller than the first threshold value, fifth icons indicative of the files including the search keyword, respectively, on the screen.

The filtering module 324 includes instructions for determining the second files which have been generated or updated within a first period, of the files including the search keyword.

The display process module 33 includes instructions for displaying, if the number of the second files determined is smaller than the second threshold value, a search result view including sixth icons indicative of the files, respectively, on the screen. The display process module 33 also includes instructions for displaying, if the number of the second files is greater than or equal to the second threshold value, a search result view including the first icon indicative of the first group and the second icon indicative of the second group, on the screen.

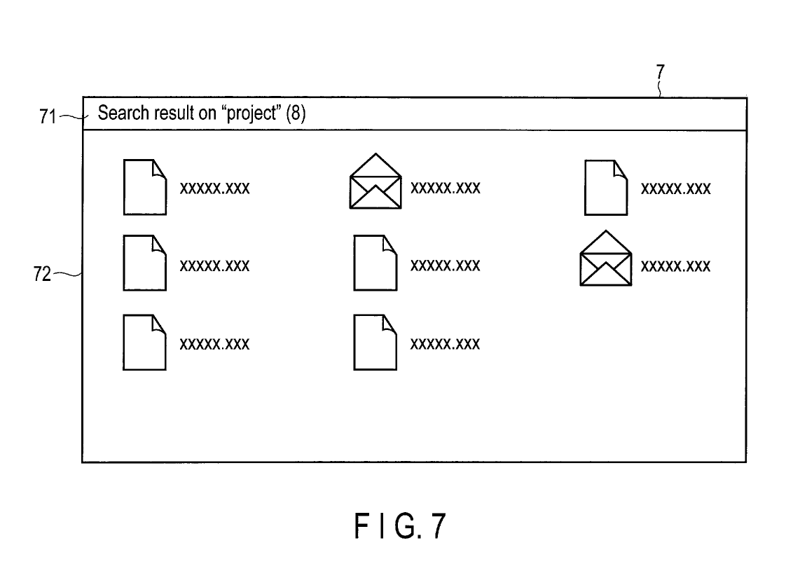

Several search result views displayed on the screen on the LCD 20A will be explained with reference to FIG. 7 to FIG. 10.

FIG. 7 shows an example of the search result views. If the number of the files (first files) including the search keyword is smaller than the first threshold value, a search result view 7 including a list of the files is displayed on the screen.

The search result view 7 includes a title bar 71 and a search result area 72. A text indicating a content of the search result is displayed in the title bar 71. In the example shown in FIG. 7, the title bar 71 indicates that the number of the search results relating to the search keyword “project” is eight.

Icons (items) indicative of searched files, respectively, are displayed in the search result area 72. In the search result area 72, not only the icons, but also file names may be displayed. By executing, for example, an operation of selecting one of the icons (for example, an operation of tapping one of the icons), the user can instruct display of the content of the file.

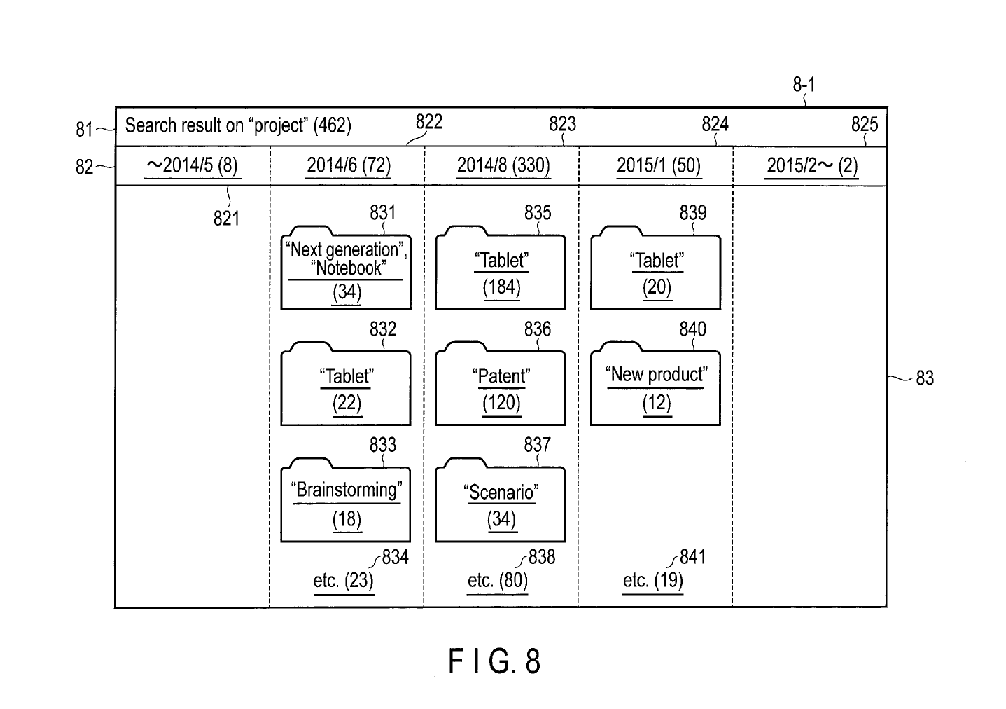

FIG. 8 shows another example of the search result views. If the number of the files including the search keyword is larger than or equal to the first threshold value, a search result view 8-1 including a list of groups of classified files including the search keyword is displayed on the screen.

The search result view 8-1 includes a title bar 81, a time area 82, and a search result area 83. A text indicative of a content of the search result is displayed in the title bar 81. In the example shown in FIG. 8, the title bar 71 indicates that the number of the search results relating to the search keyword “project” is 462.

In the time area 82, items 821 to 825 indicative of periods into which the files of the search results are classified are arranged chronologically. Each of the items 821 to 825 indicates a corresponding period and the number of the files classified into the period.

The search result area 83 is divided into areas in accordance with the items 821 to 825 indicating the periods. In the divided areas (hereinafter also referred to as divided areas), icons 831 to 841 indicative of the groups defined by keywords and the periods indicated by the items 821 to 825 are displayed. Each of the icons 831 to 841 is arranged two-dimensionally in accordance with the period defined by a first axis (in this case, horizontal axis) and the keyword defined by a second axis (in this case, vertical axis). In each of the divided areas, for example, the icons indicative of the groups are displayed in descending order of the numbers of files classified into groups, which is a predetermined number (for example, three) at maximum. Therefore, the icons indicative of the groups of a common keyword or the icons indicative of the groups of different keywords may be displayed.

For example, the icon 831 indicates the group into which files updated in June 2014 and including keywords “next generation” and “notebook” are classified. The icon 832 indicates the group into which files updated in June 2014 and including a keyword “tablet” are classified. The icon 833 indicates the group into which files updated in June 2014 and including a keyword “brainstorming” are classified. The icon 834 indicates the group into which files updated in June 2014 and including other keywords (i.e., keywords other than “next generation”, “notebook”, “tablet” and “brainstorming”) are classified.

For example, the icon 835 indicates the group into which files updated in August 2014 and including a keyword “tablet” are classified. The icon 836 indicates the group into which files updated in August 2014 and including a keyword “patent” are classified. The icon 837 indicates the group into which files updated in August 2014 and including a keyword “scenario” are classified. The icon 838 indicates the group into which files updated in August 2014 and including other keywords (i.e., keywords other than “tablet”, “patent”, and “scenario”) are classified.

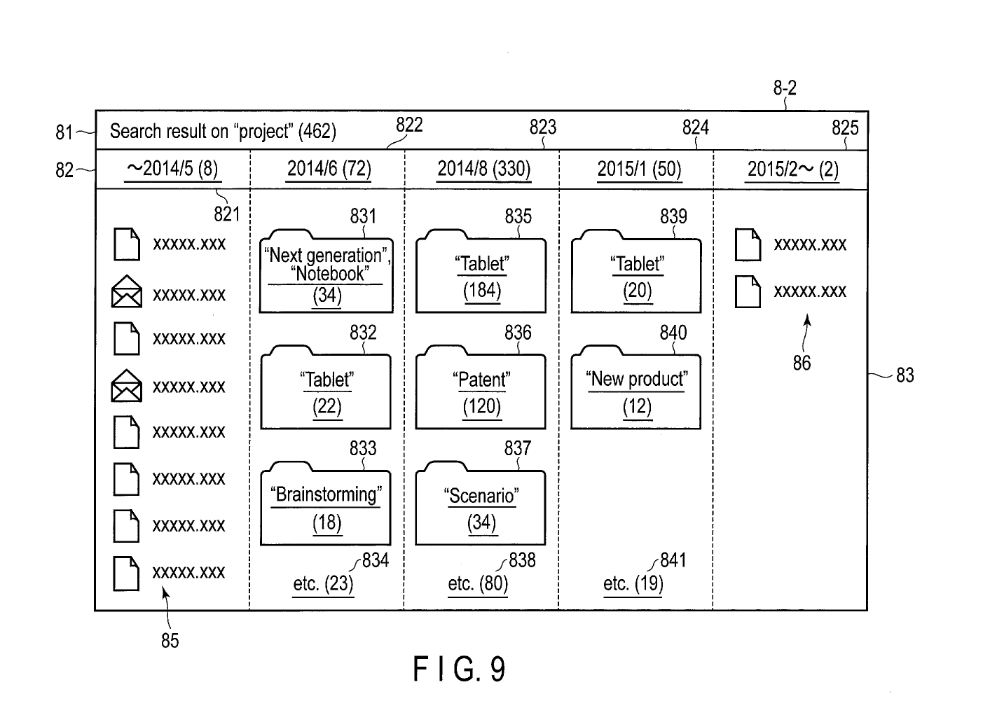

As shown in a search result view 8-2 in FIG. 9, if the number of files updated (or generated) in a certain period (i.e., the number of files which should be displayed in a certain divided area) is smaller than the second threshold value, not the icons indicative of the groups, but a list of the icons indicative of the files may be displayed in a corresponding divided area in the search result area 83. In the example shown in FIG. 9, in a divided area 85 corresponding to May 2014 and a divided area 86 corresponding to February 2015, in which the number of updated files is smaller than ten, the icons indicative of the files updated in the respective periods are displayed.

Thus, in relation to the period in which the number of the classified files is smaller than the second threshold value (for example, ten), the icons indicating not the groups, but the files may be displayed in the search result area 83 since the user can easily select a necessary file from a list of files whose number is smaller than the second threshold value.

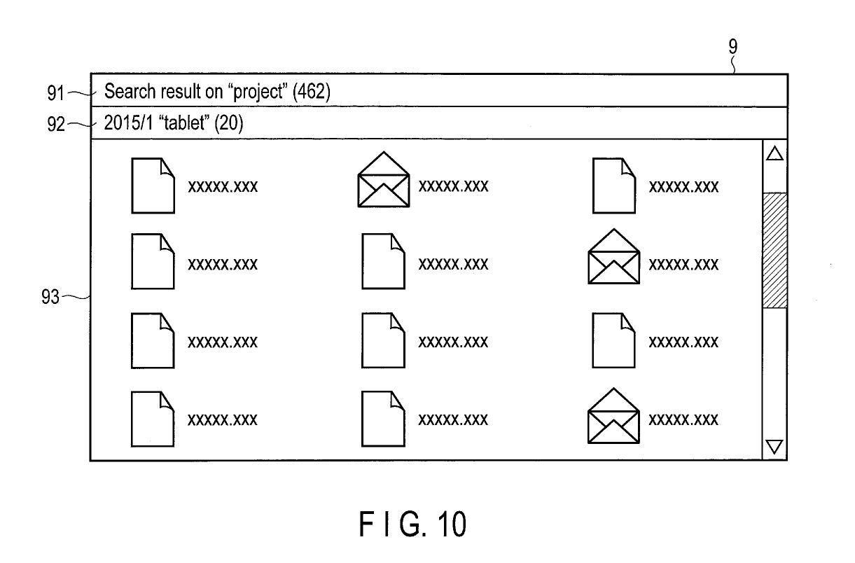

In addition, by executing an operation of selecting one of the icons 831 to 841 indicative of the groups in the search result view 8-1 shown in FIG. 8 or the search result view 8-2 shown in FIG. 9 (for example, an operation of tapping one of the icons), the user can instruct display of the search result view including the list of the files belonging to the corresponding group. FIG. 10 shows an example of the search result view 9 displayed in a case where the icon 839 indicative of the group is selected.

The search result view 9 includes a title bar 91, a group bar 92, and a search result area 93. A text indicative of a content of the search result is displayed in the title bar 91. A text indicative of a content of the selected group is displayed in the group bar 92. In the example shown in FIG. 10, the group bar 92 indicates that the number of the files updated in January 2015 and including a keyword “tablet” is twenty.

A list of icons indicative of respective files updated in January 2015 and including the keyword “tablet” is displayed in the search result area 93. In the search result area 93, not only the icons, but also file names may be displayed. By executing, for example, an operation of selecting one of the icons (for example, an operation of tapping one of the icons), the user can instruct display of the content of the file.

By executing an operation of selecting one of the items 821 to 825 indicative of the periods in the search result view 8-1 shown in FIG. 8 or the search result view 8-2 shown in FIG. 9, the user can also instruct display of the view including the list of the files updated in the corresponding period.

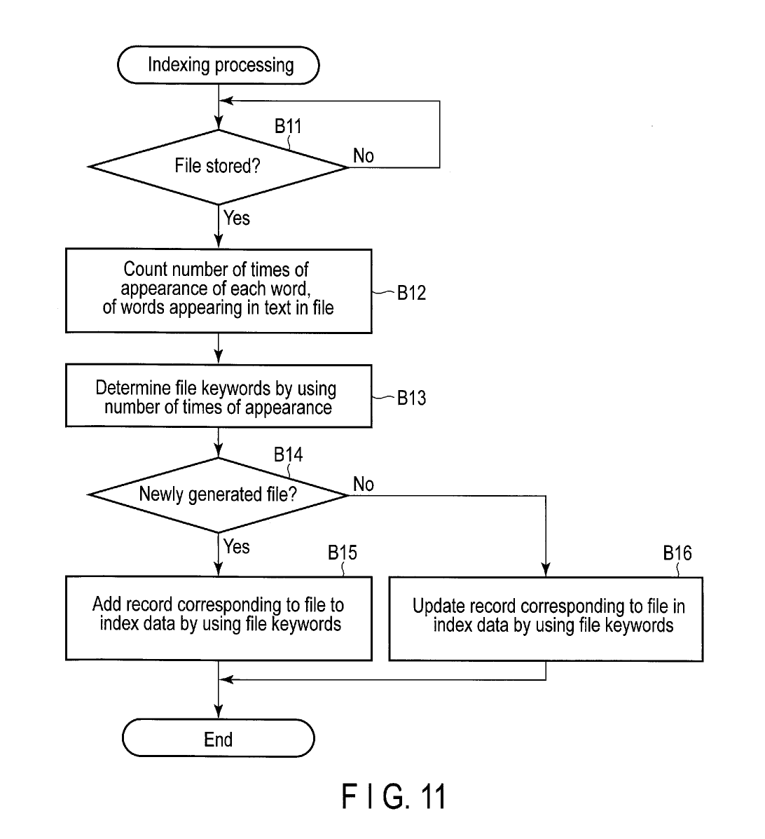

Next, an example of the procedure of indexing processing to generate the index data of a file will be explained with reference to a flowchart of FIG. 11.

The CPU 101 of the tablet computer 10 determines whether a file has been stored in the storage medium (for example, the nonvolatile memory 104) or not (block B11). The stored file may be a newly generated file or a file updated by editing an already stored file. The CPU 101 may be configured to successively detect storing a file or to determine whether a file has been stored or not at each predetermined time. If a file is not stored (No in block B11), it is determined again whether a file has been stored or not, by returning to block B11.

If a file has been stored (Yes in block B11), the CPU 101 counts the number of times of appearance of each word, of the words appearing in the text in the file (block B12). The CPU 101 determines words which are to be used as file keywords, of the words, by using the counted number of times of appearance of each word (block B13). The CPU 101 determines, for example, a predetermined number of (for example, ten) words in order of more number of times of appearance, as the file keywords. In addition, the CPU 101 may determine, for example, the words having the number of times of appearance more than or equal to a predetermined number (for example, five), as the file keywords. Furthermore, the CPU 101 may determine all the appearing words as the file keywords.

The CPU 101 may detect idioms composed of words (for example, “new product”), in the text in the file, by using the dictionary data (linguistic knowledge), and count the number of times of appearance of each idiom. In this case, the CPU 101 determines the word and idiom which are to be used as file keywords, of the words and idioms appearing in the file, based on the counted number of times of appearance.

Next, the CPU 101 determines whether the file is a newly generated file or not (block B14). Instead, the CPU 101 may determine whether the record corresponding to the file has been already generated in the index data 104B or not. If the file is a newly generated file (Yes in block B14), the CPU 101 adds the record corresponding to the file to the index data 104B, by using the determined file keywords (block B15). In contrast, if the file is not a newly generated file (No in block B14), i.e., if the file is an updated file, the CPU 101 updates the record corresponding to the file in the index data 104B by using the determined file keywords (block B16).

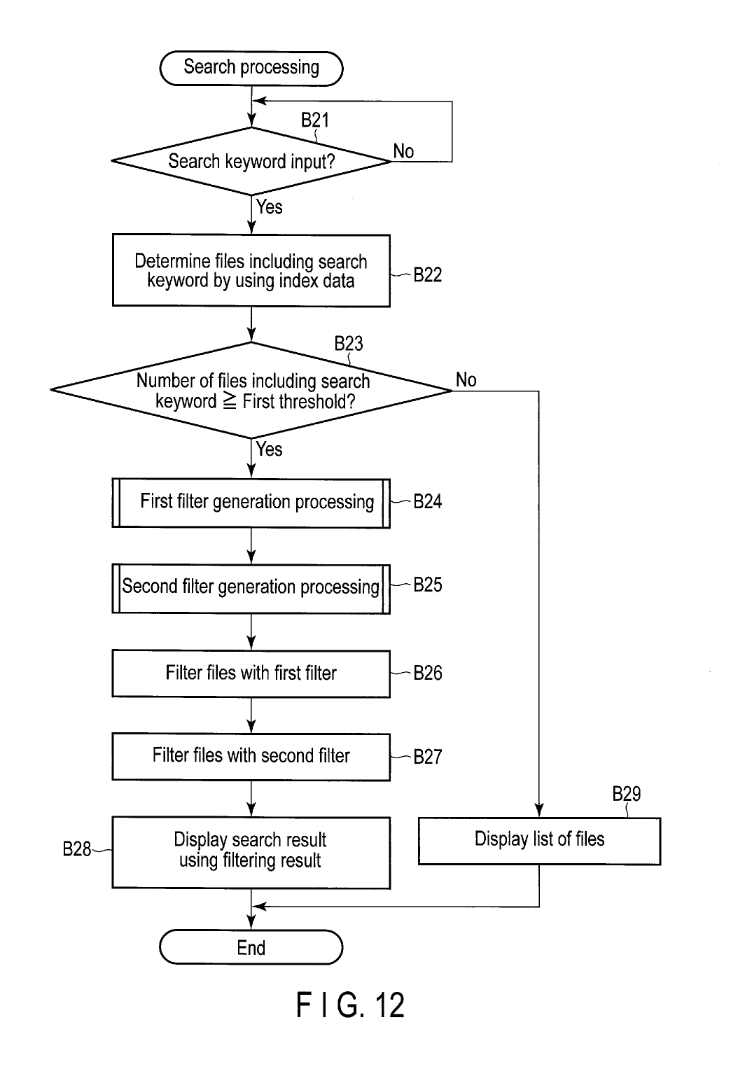

A flowchart of FIG. 12 shows an example of the procedure of search processing based on input search keyword.

First, the CPU 101 of the tablet computer 10 determines whether the search keyword has been input or not (block B21). If the search keyword has not been input (No in block B21), it is determined again whether the search keyword has been input or not, by returning to block B21.

If the search keyword has been input (Yes in block B21), the CPU 101 determines the files including the search keyword from the files 104A stored in the nonvolatile memory 104, by using the index data 104B (block B22). Then, the CPU 101 determines whether the number of the files including the search keyword is larger than or equal to the first threshold value or not (block B23).

If the number of the files including the search keyword is larger than or equal to the first threshold value (Yes in block B23), the CPU 101 executes processing of generating the first filter (block B24) and executes processing of generating the second filter (block B25). The first filter is a filter to narrow the files to files having the dates of updating (or dates of generation) which fall within in a certain period. The second filter is a filter to narrow the files to files including a certain keyword. The first filter generation processing and the second filter generation processing may be executed sequentially or in parallel. An example of the procedure of the first filter generation processing will be explained later with reference to FIG. 11. In addition, an example of the procedure of the second filter generation processing will be explained later with reference to FIG. 12.

The CPU 101 filters the files including the search keyword, with the generated first filter (block B26). The files including the search keyword are thereby narrowed with reference to the dates of updating (or the dates of generation). In other words, the files including the search keyword are classified into groups of periods, based on the dates of updating.

Next, the CPU 101 filters the files belonging to the groups of the periods, which are the filtering results using the first filter, with the generated second filter (block 327). The files belonging to each of the groups of the periods are narrowed with respect to each of the keywords. In other words, the files belonging to each of the groups of the periods are classified into the groups of the plural keywords. According to the filtering result, the files including the search keyword are therefore classified into groups defined by one of the periods classified with the first filter and one of the keywords classified with the second filter.

The CPU 101 displays the search result using the filtering result in block B27, on the screen of the LCD 20A (block B28). The CPU 101 displays, for example, the first icon indicative of the first group defined by the first period of the periods and the second keyword of the filter keywords, on the screen of the LCD 20A. If the first icon indicative of the first group is selected (for example, tapped), the CPU 101 displays on the screen the files (a list of the files) which have been generated or updated in the first period and which include the second keyword, of the files including the search keyword.

If the number of the files including the search keyword is smaller than the first threshold value (No in block B23), the CPU 101 displays a list of icons indicative of the files including the search keyword, on the screen of the LCD 20A (block B29).

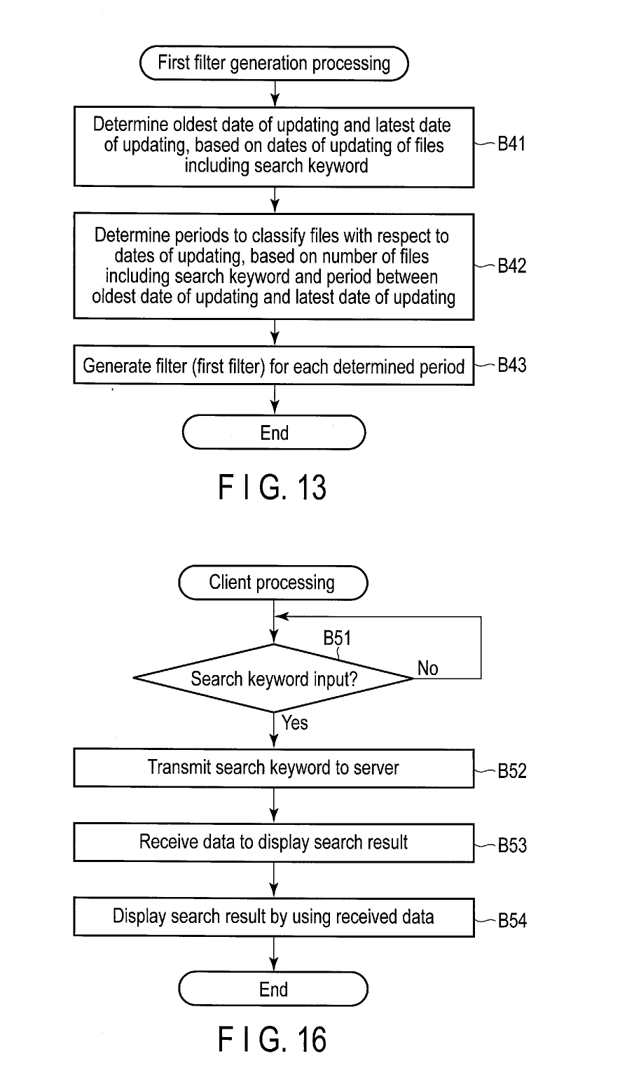

A flowchart of FIG. 13 shows an example of the procedure of the first filter generation processing.

The CPU 101 of the tablet computer 10 determines the oldest date of updating and the latest date of updating, based on the dates of updating of the respective files including the search keyword (block B41). The CPU 101 determines periods to classify the files with respect to the dates of updating (or the dates of generation), based on the number of files including the search keyword and a period between the oldest date of updating and the latest date of updating (block B42). The CPU 101 counts, for example, the number of updated files in each predetermined unit period (for example, one month), in the period between the oldest date of updating and the latest date of updating. If all the counted numbers of updated files in the respective unit periods are smaller than or equal to a fifth threshold value, the CPU 101 determines the periods per unit period as periods to classify the files with respect to the dates of updating.

The CPU 101 generates the filter for each of the determined periods (block B43).

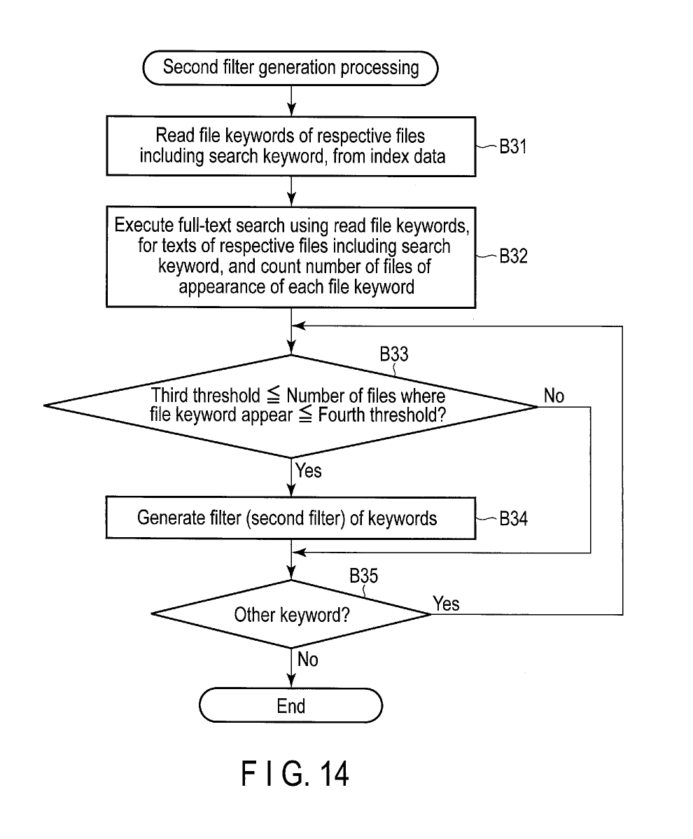

Next, an example of the procedure of the second filter generation processing will be explained with reference to a flowchart of FIG. 14.

First, the CPU 101 of the tablet computer 10 reads the file keywords of the respective files including the search keyword, from the index data 104B (block B31). More specifically, the CPU 101 acquires the file keywords by reading the contents described in the “file keyword” fields from the records corresponding to the files including the search keyword, in the index data 104B.

The CPU 101 executes full-text search using the read file keywords, for the texts of the respective files including the search keyword, and counts the number of files of appearance of each file keyword (block B32).

Then, the CPU 101 determines whether the counted number of the files in which each file keyword appears is larger than or equal to the third threshold value and smaller than or equal to the fourth threshold value, or not (block B33). It should be noted that the fourth threshold value is larger than the third threshold value. If the counted number of files in which each file keyword appears is larger than or equal to the third threshold value and smaller than or equal to the fourth threshold value (Yes in block B33), the CPU 101 determines the file keyword as the filter keyword to classify the files including the search keyword and generates the filter (second filter) of the keyword (block B34). The filter of the keyword is a filter to narrow the files including the search keyword to the files which further include the filter keyword. If the counted number of the files in which the file keyword appears is smaller than the third threshold value or larger than the fourth threshold value (No in block B33), the procedure of block B34 is skipped.

Next, the CPU 101 determines whether the other file keyword has been read in block B31 or not (block B35). If the other file keyword has been read (Yes in block B35), the processing relating to the other file keyword is executed by returning to block B33. If the other file keyword has not been read (No in block B35), i.e., if the processing relating to all the file keywords of the files is completed, the processing is ended.

In the present embodiment, as explained above, if a first keyword is input, the CPU 101 determines first files including the first keyword, of files stored in the nonvolatile memory 104 or the like. The CPU 101 determines a first period and a second period to classify the first files with respect to the dates of generation or the dates of updating, and a second keyword and a third keyword to classify the first files. The CPU 101 displays a first icon, a second icon, a third icon and a fourth icon on the screen of the LCD 20A. The first icon indicates the first group of first files which have been generated or updated in the first period and which include the second keyword. The second icon indicates the second group of first files which have been generated or updated in the first period and which include the third keyword. The third icon indicative of the third group of first files which have been generated or updated in the second period and which include the second keyword. The fourth icon indicates the fourth group of first files which have been generated or updated in the second period and which include the third keyword. If the first icon is selected, the CPU 101 displays the first files which have been generated or updated in the first period and which include the second keyword, on the screen. In addition, the first icon, the second icon, the third icon and the fourth icon are arranged two-dimensionally in accordance with the periods determined by one of axes and the keywords determined by the other axis.

The user can thereby find a file in the group defined by the period based on the date of updating or the date of generation and the keyword and, for example, if the number of files including the search keyword is large, user's labor to add conditions based on the date of updating or the keyword can be reduced and the user can be assisted to easily obtain the file which the user expects.

The above configuration can also be employed to recognize the summary of the files 104A (contents) stored in the nonvolatile memory 104. In this case, inputting the search keyword is dispensable. The first filter generation module 322 and the second filter generation module 323 include instructions for determining the periods to classify the files 104A with respect to the dates of updating (or the dates of generation) and determining the keywords (filter keywords) to classify the files 104A with respect to the keywords. The display process module 33 includes instructions for displaying on the screen the icons indicative of the groups that are defined by one of the determined periods and one of the determined filter keywords, respectively. The user can recognize the summary of the files 104A by using the groups of the periods and the keywords into which the files 104A are classified.

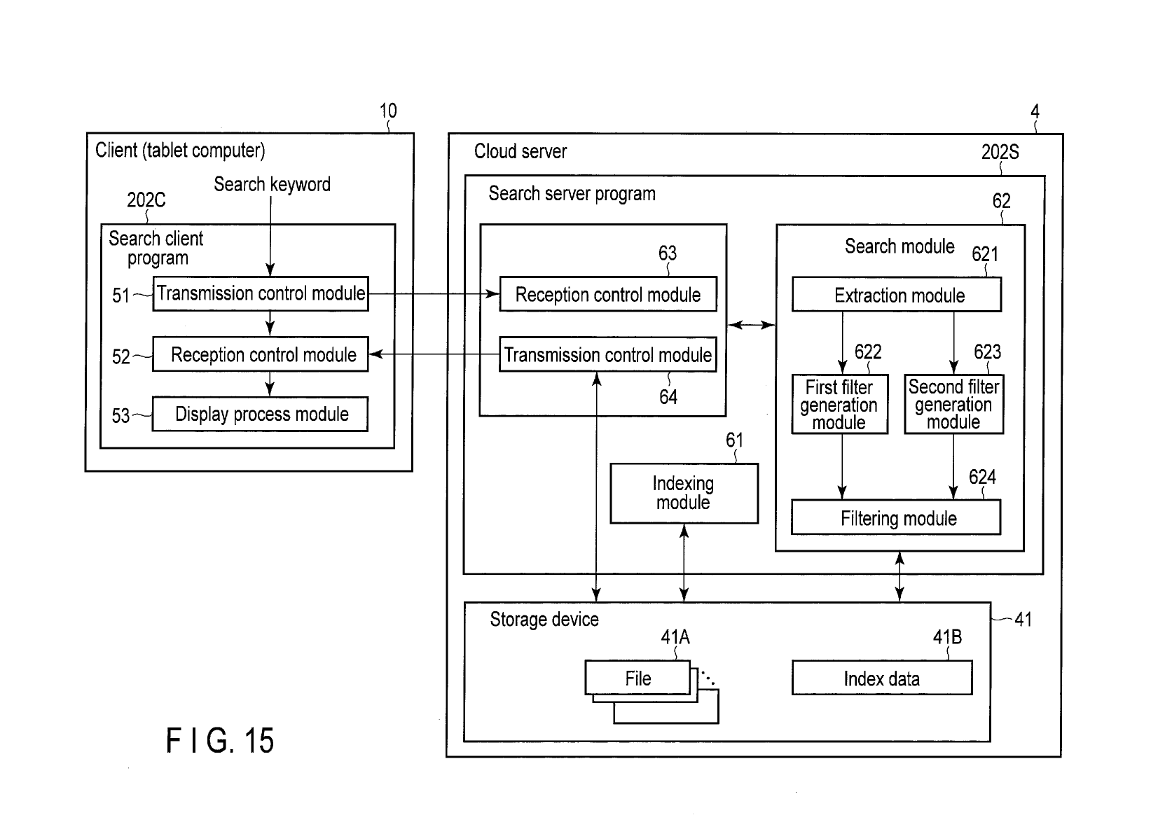

In addition, as shown in FIG. 15, files 41A stored in a storage device 41 in an external electronic device (cloud server) 4 can be searched by a keyword via a network in a similar manner. A client which is the tablet computer 10 is interconnected with the cloud server (server computer) 4 via the network. The CPU 101 of the client 10 executes a search client program 202C loaded from the nonvolatile memory 104 to the main memory 103. The cloud server 4 includes a CPU, a main memory, a nonvolatile memory (storage device), a BIOS-ROM, a LAN controller, a wireless LAN controller, and the like, similarly to, for example, the system configuration of the tablet computer 10 shown in FIG. 2. The CPU of the cloud server 4 executes the OS and various application programs including the search server program 202S loaded from the nonvolatile memory (storage device) to the main memory.

The search client program 202C executed by the CPU 101 in the client 10 includes a transmission control module 51, a reception control module 52 and a display process module 53 as functional modules of the program.

The search server program 202S executed by the CPU in the cloud server 4 includes an indexing module 61, a search module 62, a reception control module 63, and a transmission control module 64 as functional modules of the program. The search module 62 includes an extraction module 621, a first filter generation module 622, a second filter generation module 623, and a filtering module 624. The indexing module 61 and the search module 62 include the same instructions as the indexing module 31 and the search module 32 in the search program 202 explained with reference to FIG. 3, respectively.

The indexing module 61 of the cloud server 4 includes instructions for generating, if the file 41A is stored in the storage device 41, index data corresponding to the file. The file 41A stored in the storage device 41 may be a file generated or updated in the cloud server 4 or a file generated or updated in the client 10 and transmitted from the client 10 to the cloud server 4 via the network.

The transmission control module 51 of the client 10 includes instructions for transmitting the search keyword input by the user to the cloud server 4 via a communication device (for example, the LAN controller 107 or the wireless LAN controller 108) in the client 10.

The reception control module 63 of the cloud server 4 includes instructions for receiving the search keyword from the client 10 via a communication device (for example, the LAN controller or the wireless LAN controller) in the cloud server 4.

The extraction module 621 includes instructions for extracting the files including the received search keyword, from the files 104A stored in the nonvolatile memory 104, by using the index data 41B. The extraction module 621 includes instructions for specifying the record in which the search keyword is described in the “file keyword” field, in the index data 41B. The extraction module 621 further includes instructions for determining a file corresponding to the record (i.e., a file indicated in the “file” field of the record) as the file including the search keyword.

The first filter generation module 622 includes instructions for determining periods to classify the files (first files) including the search keyword with respect to the dates of generation or the dates of updating (or the dates and times of generation or the dates and times of updating). The first filter generation module 622 includes instructions for generating a first filter to narrow the files including the search keyword to the files in which the dates of generation or the dates of updating are included in the periods, respectively. In other words, the first filter is a time filter to classify the files including the search keyword into groups of periods, based on the dates of updating.

The second filter generation module 623 includes instructions for determining keywords (filter keywords) to classify the files including the search keyword, by the keywords. The second filter generation module 623 includes instructions for determining, for example, words of the words included in the files including the search keyword as the filter keywords in a case where the number of the files in which the words appear is larger than or equal to a third threshold value and smaller than or equal to a fourth threshold value. The second filter generation module 623 includes instructions for generating a second filter to narrow the files including the search keyword to the files further including the filter keywords. In other words, the second filter is a keyword filter to narrow the files including the search keyword into groups, based on the keywords.

The filtering module 624 includes instructions for filtering the files including the search keyword, with the generated first filter and second filter. More specifically, the filtering module 624 includes instructions for filtering the files including the search keyword, with the first filter. The filtering module 624 further includes instructions for filtering the files belonging to the groups of the periods which are the filtering results using the first filter, with the second filter. Thus, the files including the search keyword are classified into the groups of the periods, based on the dates of updating, and the files belonging to each of the groups of the periods are further classified into the groups of the keywords.

The transmission control module 64 includes instructions for transmitting the data to display the filtering result on the screen, to the client 10, via a communication device (for example, the LAN controller or the wireless LAN controller) in the cloud server 4.

More specifically, the transmission control module 64 includes instructions for transmitting, if the number of files including the search keyword is greater than or equal to the first threshold value, to the client 10 the first data to display on the screen icons indicative of the groups defined by one of the periods to classify the files including the search keyword with respect to the dates of updating and one of the filter keywords to classify the files including the search keyword with respect to the keywords. The first data includes, for example, the data of the periods and keywords which define the respective groups.

For example, the first filter generation module 622 includes instructions for determining a first period and a second period to classify the first files including the search keyword with respect to the dates of generation or the dates of updating. The second filter generation module 623 includes instructions for determining a second keyword and a third keyword to classify the files including the search keyword. The transmission control module 64 includes instructions for transmitting to the client first data to display on the screen a first icon indicative of a first group of first files which have been generated or updated in the first period and which include the second keyword, a second icon indicative of a second group of first files which have been generated or updated in the first period and which include the third keyword, a third icon indicative of a third group of first files which have been generated or updated in the second period and which include the second keyword, and a fourth icon indicative of a fourth group of first files which have been generated or updated in the second period and which include the third keyword.

The reception control module 52 of the client 10 includes instructions for receiving the first data from the cloud server 4, and the display process module 53 includes instructions for displaying a search result view including the first icon, the second icon, the third icon and the fourth icon on the screen by using the received first data. The first icon, the second icon, the third icon and the fourth icon are arranged two-dimensionally in accordance with the periods determined by one of axes and the keywords determined by the other axis. The transmission control module 51 includes instructions for transmitting, if the first icon is selected from the displayed icons, the data indicative of the first icon to the cloud server 4.

The reception control module 63 of the cloud server 4 includes instructions for receiving the data indicative of the selected first data from the client 10. The transmission control module 64 and the search module 62 include instructions for transmitting second data to display on the screen the first files which have been generated or updated in the first period and which include the second keyword, of the files including the search keyword, to the client 10, based on the received data. The second data includes, for example, data such as file names (file paths) and file attributes of the respective files.

The reception control module 52 of the client 10 includes instructions for receiving the second data from the cloud server 4, and the display process module 53 includes instructions for displaying on the screen the first files which have been generated or updated in the first period and which include the second keyword, by using the received second data.

The transmission control module 64 includes instructions for transmitting, if the number of the files including the search keyword is smaller than the first threshold value, third data to display fifth icons indicative of the files including the search keyword, respectively, to the client 10. The third data includes, for example, data such as file names (file paths) and file attributes of the respective files.

The reception control module 52 of the client 10 includes instructions for receiving the third data from the cloud server 4, and the display process module 53 includes instructions for displaying a search result view including the fifth icons on the screen by using the received third data.

An example of the procedure of the search processing executed in the client 10 will be explained with reference to a flowchart of FIG. 16.

The CPU 101 of the client 10 determines whether the search keyword has been input or not (block B51). If the search keyword has not been input (No in block B51), it is determined again whether the search keyword has been input or not, by returning to block B51.

If the search keyword has been input (Yes in block B51), the CPU 101 transmits the input search keyword to the cloud server 4 via a communication device (for example, the LAN controller 107 or the wireless LAN controller 108) in the client 10 (block B52). The CPU 101 then receives the data to display the search result, which has been transmitted by the cloud server 4, via the communication device in the client 10 (block B53).

The CPU 101 displays the search result views 7, 8-1, and 8-2 shown in FIG. 7 to FIG. 9, on the screen, by using the received data (block B54).

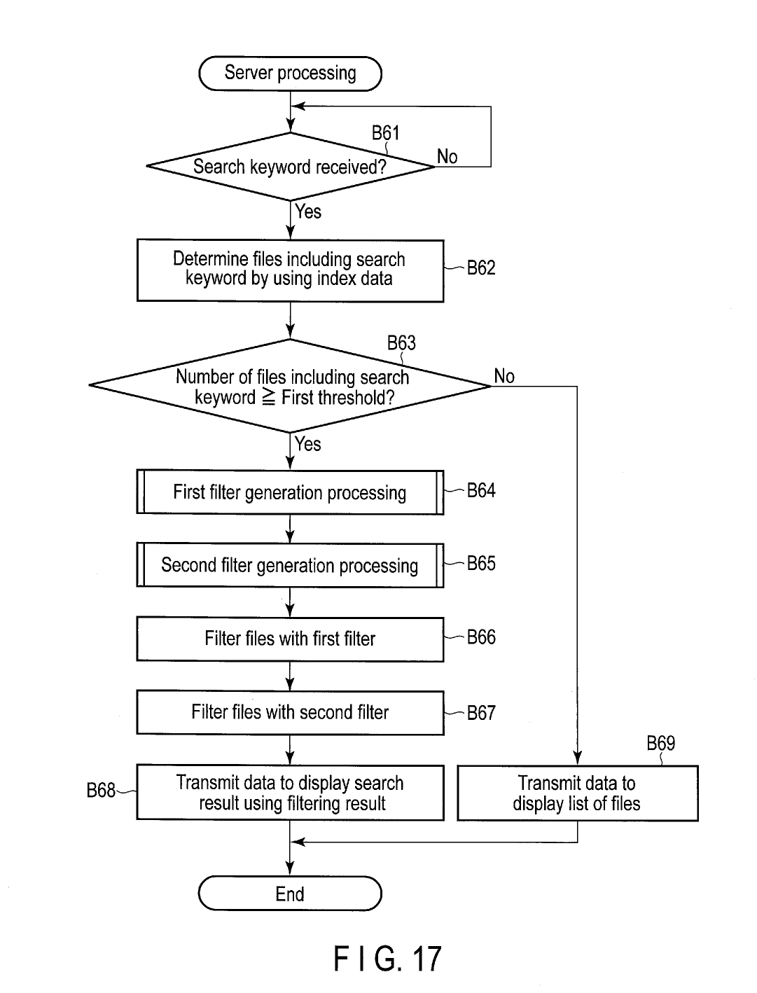

A flowchart of FIG. 17 shows an example of the procedure of the search processing executed in the cloud server 4.

The CPU of the cloud server 4 determines whether the search keyword transmitted by the client 10 has been received or not (block B61). If the search keyword has not been received (No in block B61), it is determined again whether the search keyword has been received or not, by returning to block B61.

If the search keyword has been received (Yes in block B61), the CPU determines the files including the search keyword from the files 41A stored in the storage device 41, by using the index data 41B (block B62). Then, the CPU determines whether the number of the files including the search keyword is larger than or equal to the first threshold value or not (block B63).

If the number of the files including the search keyword is larger than or equal to the first threshold value (Yes in block B63), the CPU executes processing of generating the first filter (block B64) and executes processing of generating the second filter (block B65). The first filter is a filter to narrow the files to files having the dates of updating (or dates of generation) which fall within in a certain period. The second filter is a filter to narrow the files to files including a certain keyword. The second filter generation processing and the first filter generation processing may be executed sequentially or in parallel. The example of the procedure of the first filter generation processing has been explained above with reference to FIG. 11. The example of the procedure of the second filter generation processing has been explained above with reference to FIG. 12.

The CPU filters the files including the search keyword, with the generated first filter (block B66). The files including the search keyword are thereby narrowed with reference to the dates of updating (or the dates of generation). In other words, the files including the search keyword are classified into groups of periods, based on the dates of updating.

The CPU filters the files belonging to the groups of the periods, which are the filtering results using the first filter, with the generated second filter (block B67). The files belonging to each of the groups of the periods are narrowed with respect to each of the keywords. In other words, the files belonging to each of the groups of the periods are classified into the groups of the keywords.

The CPU transmits the data to display the search result using the filtering result of block B67 on the screen, to the client 10, via a communication device (for example, the LAN controller or the wireless LAN controller) in the cloud server 4 (block B68).

If the number of the files including the search keyword is smaller than the first threshold value (No in block B63), the CPU transmits data to display a list of the files including the search keyword on the screen, to the client 10, via the communication device in the cloud server 4 (block B69).

In the present embodiment, as explained above, the transmitter 107T or 108T transmits the first keyword to search the files to the cloud server 4. The receiver 107R or 108R receives from the cloud server 4 the first data to display on the screen a first icon indicative of a first group of first files which include the first keyword, a second icon indicative of a second group of the first files, a third icon indicative of a third group of the first files, and a fourth icon.indicative of a fourth group of the first files. The first group of the first files has been generated or updated in the first period and includes the second keyword. The second group of the first files has been generated or updated in the first period and includes the third keyword. The third group of the first files has been generated or updated in the second period and includes the second keyword. The fourth group of the first files has been generated or updated in the second period and includes the third keyword. The CPU 101 displays the first icon, the second icon, the third icon and the fourth icon on the screen of the LCD 20A by using the received first data. The first icon, the second icon, the third icon and the fourth icon are arranged two-dimensionally in accordance with the periods determined by one of axes and the keywords determined by the other axis. If the first icon is selected, the receiver 107R or 108R further receives second data to display on the screen the first files which have been generated or updated in the first period and which include the second keyword, from the cloud server 4. The CPU 101 further displays the first files which have been generated or updated in the first period and which include the second keyword, on the screen, by using the received second data.

The user can thereby find a file including the search keyword in the group defined by the period based on the date of updating or the date of generation and the keyword when the user searches the files in the cloud server 4 on the network and, for example, if the number of files including the search keyword is large, the user can be assisted to easily obtain the file which the user expects.

Each of various functions described in the embodiment may be implemented by a circuit (processing circuit). Examples of the processing circuit include a programmed processor such as a central processing unit (CPU). The processor executes each of the described functions by executing the computer program (instructions) stored in the memory. The processor may be a microprocessor including an electric circuit. Examples of the processing circuit include electric circuit components of a digital signal processor (DSP), application specific IC (ASIC), a microcomputer, a controller, and the like. Each of the components other than the CPU explained in the embodiment may also be implemented by a processing circuit.

In addition, since various types of the processing of the present embodiment can be implemented by the computer program, the same advantage as that of the present embodiment can easily be obtained by installing the computer program via a computer-readable storage medium storing the computer program in a general computer and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a screen;
a memory that stores files; and
a hardware processor configured to:
determine, if a first keyword is input, first files comprising the first keyword, of the files;
determine a first period and a second period to classify the first files with respect to dates of generation or dates of updating, and a second keyword and a third keyword to classify the first files;
display a first icon, a second icon, a third icon and a fourth icon on a screen, the first icon indicative of a first group of the first files which have been generated or updated in the first period and which comprise the second keyword, the second icon indicative of a second group of the first files which have been generated or updated in the first period and which comprise the third keyword, the third icon indicative of a third group of the first files which have been generated or updated in the second period and which comprise the second keyword, the fourth icon indicative of a fourth group of the first files which have been generated or updated in the second period and which comprise the third keyword; and
display the first files which have been generated or updated in the first period and which comprise the second keyword, on the screen, if the first icon is selected,
the first icon, the second icon, the third icon and the fourth icon being arranged two-dimensionally in accordance with periods defined by one of axes and keywords defined by the other axis.

2. The electronic device of claim 1, wherein the hardware processor is further configured to:
display fifth icons indicative of the first files on the screen if a first number of the first files is smaller than a first threshold value; and
display the first icon, the second icon, the third icon and the fourth icon on the screen if the first number is larger than or equal to the first threshold value.

3. The electronic device of claim 1, wherein the hardware processor is further configured to:
determine at least one second file that has been generated or updated in the first period, of the first files;
display at least one sixth icon indicative of the at least one second file on the screen if a second number of the at least one second file is smaller than a second threshold value; and
display the first icon and the second icon on the screen if the second number is larger than or equal to the second threshold value.

4. The electronic device of claim 1, wherein the second keyword and the third keyword comprise a word having a number of files in which the word appears larger than or equal to a third threshold value and smaller than or equal to a fourth threshold value, of words included in the first files.

5. The electronic device of claim 1, wherein a number of files which have been generated or updated in the first period and a number of files which have been generated or updated in the second period, of the first files, are smaller than or equal to a fifth threshold value.

6. The electronic device of claim 1, wherein the second keyword or the third keyword comprises words.

7. A method, comprising:
causing a memory to store files;
determining, if a first keyword is input, first files comprising the first keyword, of the files;
determining a first period and a second period to classify the first files with respect to dates of generation or dates of updating, and a second keyword and a third keyword to classify the first files;
displaying a first icon, a second icon, a third icon and a fourth icon on a screen, the first icon indicative of a first group of the first files which have been generated or updated in the first period and which comprise the second keyword, the second icon indicative of a second group of the first files which have been generated or updated in the first period and which comprise the third keyword, the third icon indicative of a third group of the first files which have been generated or updated in the second period and which comprise the second keyword, the fourth icon indicative of a fourth group of the first files which have been generated or updated in the second period and which comprise the third keyword; and
displaying the first files which have been generated or updated in the first period and which comprise the second keyword, on the screen, if the first icon is selected,
the first icon, the second icon, the third icon and the fourth icon being arranged two-dimensionally in accordance with periods defined by one of axes and keywords defined by the other axis.

8. The method of claim 7, further comprising:
displaying fifth icons indicative of the first files on the screen if a first number of the first files is smaller than a first threshold value; and
displaying the first icon, the second icon, the third icon and the fourth icon on the screen if the first number is larger than or equal to the first threshold value.

9. The method of claim 7, further comprising:
determining at least one second file that has been generated or updated in the first period, of the first files;
displaying at least one sixth icon indicative of the at least one second file on the screen if a second number of the at least one second file is smaller than a second threshold value; and
displaying the first icon and the second icon on the screen if the second number is larger than or equal to the second threshold value.

10. The method of claim 7, wherein the second keyword and the third keyword comprise a word having a number of files in which the word appears larger than or equal to a third threshold value and smaller than or equal to a fourth threshold value, of words included in the first files.

11. The method of claim 7, wherein a number of files which have been generated or updated in the first period and a number of files which have been generated or updated in the second period, of the first files, are smaller than or equal to a fifth threshold value.

12. The method of claim 7, wherein the second keyword or the third keyword comprises words.

13. An electronic device, comprising:
a transmitter configured to transmit a first keyword to search files to an external electronic device;
a receiver configured to receive first data from the external electronic device, the first data for displaying a first icon, a second icon, a third icon and a fourth icon on a screen, the first icon indicative of a first group of first files comprising the first keyword, of the files, the second icon indicative of a second group of the first files, the third icon indicative of a third group of the first files, the fourth icon indicative of a fourth group of the first files, the first group of the first files having been generated or updated in a first period and comprising a second keyword, the second group of the first files having been generated or updated in the first period and comprising a third keyword, the third group of the first files having been generated or updated in a second period and comprising the second keyword, the fourth group of the first files having been generated or updated in the second period and comprising the third keyword; and
a hardware processor configured to display the first icon, the second icon, the third icon and the fourth icon on a screen, by using the received first data,
wherein the first icon, the second icon, the third icon and the fourth icon are arranged two-dimensionally in accordance with periods defined by one of axes and keywords defined by the other axis,
the receiver is further configured to receive second data from the external electronic device if the first icon is selected, the second data for displaying the first files generated or updated in the first period and comprising the second keyword on a screen, and
the hardware processor is further configured to display the first files which have been generated or updated in the first period and which comprise the second keyword, on the screen, by using the received second data.

14. The electronic device of claim 13, wherein
the receiver is further configured to receive third data from the external electronic device if a first number of the first files is smaller than a first threshold value, the third data for displaying fifth icons indicative of the first files on a screen,
the hardware processor is further configured to display the fifth icons on a screen by using the received third data,
the receiver is further configured to receive the first data from the external electronic device if the first number is larger than or equal to the first threshold value, and
the hardware processor is further configured to display the first icon, the second icon, the third icon and the fourth icon on the screen by using the received first data.

15. The electronic device of claim 13, wherein
the receiver is further configured to receive fourth data if a number of at least one second file which have been generated or updated in the first period, of the first files, is smaller than a second threshold value, the fourth data for displaying at least one sixth icon indicative of the at least one second file on a screen, and
the hardware processor is further configured to display the sixth icon on the screen by using the received fourth data.

16. The electronic device of claim 13, wherein the second keyword and the third keyword comprise a word having the a number of files in which the word appears larger than or equal to a third threshold value and smaller than or equal to a fourth threshold value, of words included in the first files.

17. The electronic device of claim 13, wherein a number of files generated or updated in the first period and a number of files generated or updated in the second period, of the first files, are smaller than or equal to a fifth threshold value.

18. The electronic device of claim 13, wherein the second keyword or the third keyword comprises words.
